(19) United States
(12) Patent Application Publication
(10) Pub. No.: US 2025/0216076 A1
(43) Pub. Date: Jul. 3, 2025

(54) ADDITIVELY MANUFACTURED COMBUSTOR BODY WITH RESONATING TUBE

(71) Applicant: GE Infrastructure Technology LLC, Greenville, SC (US)

(72) Inventor: Richard Martin DiCintio, Simpsonville, SC (US)

(21) Appl. No.: 18/399,852

(22) Filed: Dec. 29, 2023

(51) Int. Cl. F23R 3/00; B22F 5/00; B33Y 80/00

(52) U.S. Cl. CPC F23R 3/002; B22F 5/009; B33Y 80/00; F23R 2900/00014

(57) ABSTRACT

A combustor includes an additively manufactured (AM) combustor body including a one-piece member including: a combustion liner defining a combustion chamber and including cylindrical and tapered transition portions. A resonating tube is part of the AM combustor body and is configured to dampen acoustic pressure oscillations of combustion gases in the combustor. The AM combustor body includes a plurality of parallel, sintered metal layers. The resonating tube includes a body defining a resonating chamber and a resonating tube neck having a first end in fluid communication with the resonating chamber. A second end of the resonating tube is in fluid communication with an annulus or the combustion chamber.

### TECHNICAL FIELD

The disclosure relates generally to turbomachine combustors and, more specifically, to an additively manufactured combustor body with resonating tube.

### BACKGROUND

Gas turbine systems include a combustion section including a plurality of combustors in which fuel is combusted to create a flow of combustion gases that is converted to kinetic energy in a downstream turbine (e.g., an expansion turbine). Destructive acoustic pressure oscillations, or pressure pulses, may be generated in combustors of such gas turbine systems as a consequence of normal operating conditions depending on fuel-air stoichiometry, total mass flow, and other operating conditions. The combustion instability associated with operation using low emission fuels tends to create unacceptably high dynamic pressure oscillations in the combustor which can present operability and/or durability challenges. Notably, the increase in energy release density and the rapid mixing of reactants to minimize nitrous oxide (NOx) emissions in advanced gas turbine combustors enhance the possibility of high frequency acoustics. A change in the resonating frequency of undesired acoustics is also a result of the pressure oscillations. Both low and high frequency acoustic modes can present challenges.

Additive manufacturing such as direct metal laser melting (DMLM) or selective laser melting (SLM) has emerged as a reliable manufacturing method for making combustor parts that can mitigate undesirable acoustic frequencies and/or acoustic modes.

### BRIEF DESCRIPTION

All aspects, examples and features mentioned below can be combined in any technically possible way.

One aspect of the disclosure includes a combustor for a gas turbine system, the combustor comprising: an additively manufactured (AM) combustor body including a one-piece member including: a combustion liner defining a combustion chamber and including a cylindrical portion and a tapered transition portion; and a resonating tube configured to dampen acoustic pressure oscillations of combustion gases in the combustor, the resonating tube including a body defining a resonating chamber and a resonating tube neck having a first end in fluid communication with the resonating chamber; wherein the AM combustor body includes a plurality of parallel, sintered metal layers.

Another aspect of the disclosure includes any of the preceding aspects, and further comprising an annulus surrounding at least part of the combustion liner, the annulus defined by one of a flow sleeve surrounding the at least part of the combustion liner or an annular passage in the at least part of the combustion liner.

Another aspect of the disclosure includes any of the preceding aspects, and the resonating chamber is on an outside of the annulus, and the resonating tube neck includes a second end in fluid communication with the annulus.

Another aspect of the disclosure includes any of the preceding aspects, and the resonating chamber is on an outside of the annulus, and the resonating tube neck includes a second end in fluid communication with the combustion chamber defined by the combustion liner.

Another aspect of the disclosure includes any of the preceding aspects, and the resonating chamber is positioned in the annulus, and the resonating tube neck includes a second end in fluid communication with the combustion chamber defined by the combustion liner.

Another aspect of the disclosure includes any of the preceding aspects, and the resonating chamber is spaced from an outside of the annulus by the resonating tube neck, and the resonating tube neck includes a second end in fluid communication with the annulus.

Another aspect of the disclosure includes any of the preceding aspects, and the AM combustor body includes an aft frame at an aft end of the tapered transition portion and an impingement flow sleeve surrounding the tapered transition portion; wherein the resonating chamber is on an outside of one of the tapered transition portion adjacent the aft frame and the impingement flow sleeve; and wherein an impingement annulus is defined between the impingement flow sleeve and the tapered transition portion of the combustion liner, and the resonating tube neck includes a second end in fluid communication with the combustion chamber in the combustion liner.

Another aspect of the disclosure includes any of the preceding aspects, and a portion of the resonating chamber is within the aft frame.

Another aspect of the disclosure includes any of the preceding aspects, and further comprising an impingement annulus defined in one of the tapered transition portion of the combustion liner and between an impingement flow sleeve and the tapered transition portion of the combustion liner; and wherein the resonating chamber is on an outside of the impingement annulus, and the resonating tube neck includes a second end in fluid communication with the impingement annulus.

Another aspect of the disclosure includes any of the preceding aspects, and the resonating tube is one of at least two resonating tubes, and at least one of the two resonating tubes includes: (a) a resonating chamber disposed on an outside of an annulus surrounding at least part of the combustion liner, the annulus defined by one of a flow sleeve surrounding the combustion liner or an annular passage in at least part of the combustion liner, and wherein the resonating tube neck includes a second end in fluid communication with the annulus; (b) a resonating chamber disposed on an outside of the annulus, and wherein the resonating tube neck includes a second end in fluid communication with the combustion chamber defined by the combustion liner; (c) a resonating chamber disposed within the annulus, and wherein the resonating tube neck includes a second end in fluid communication with the combustion chamber; (d) a resonating chamber spaced outside of the annulus by the resonating tube neck, and wherein the resonating tube neck includes a second end in fluid communication with the annulus; (e) a resonating chamber disposed on an outside of one of the tapered transition portion and an impingement flow sleeve surrounding the tapered transition portion; wherein the tapered transition portion includes an aft frame at an aft end of the tapered transition portion, and the resonating chamber is adjacent to the aft frame; and wherein an impingement annulus is defined between the tapered transition portion and the impingement flow sleeve, and the resonating tube neck includes a second end in fluid communication with the combustion chamber; (f) a resonating chamber at least partially disposed within the aft frame, and the resonating tube neck includes a second end in fluid communication with the combustion chamber; or (g) a resonating chamber disposed on an outside of the impingement annulus, and the resonating tube neck has a second end in fluid communication with the impingement annulus.

Another aspect of the disclosure includes any of the preceding aspects, and the at least two resonating tubes are configured to dampen different frequencies.

Another aspect of the disclosure includes a gas turbine (GT) system, comprising: a compressor section; a combustion section operatively coupled to the compressor section; and a turbine section operatively coupled to the combustion section, wherein the combustion section includes at least one combustor including an additively manufactured (AM) combustor body including a one-piece member including: a combustion liner defining a combustion chamber and including a cylindrical portion and a tapered transition portion, and a resonating tube configured to dampen acoustic pressure oscillations of combustion gases in the combustor, the resonating tube including a body defining a resonating chamber and a resonating tube neck having a first end in fluid communication with the resonating chamber, wherein the AM combustor body includes a plurality of parallel, sintered metal layers.

Another aspect of the disclosure includes any of the preceding aspects, and further comprising an annulus surrounding at least part of the combustion liner, the annulus defined by one of a flow sleeve surrounding the at least part of the combustion liner or an annular passage in the at least part of the combustion liner.

Another aspect of the disclosure includes any of the preceding aspects, and the resonating chamber is on an outside of the annulus and the resonating tube neck includes a second end in fluid communication with the annulus.

Another aspect of the disclosure includes any of the preceding aspects, and the resonating chamber is on an outside of the annulus and the resonating tube neck includes a second end in fluid communication with the combustion chamber defined by the combustion liner.

Another aspect of the disclosure includes any of the preceding aspects, and the resonating chamber is positioned in the annulus, and the resonating tube neck includes a second end in fluid communication with the combustion chamber in the combustion liner.

Another aspect of the disclosure includes any of the preceding aspects, and the resonating chamber is spaced from an outside of the annulus by the resonating tube neck, and the resonating tube neck includes a second end in fluid communication with the annulus.

Another aspect of the disclosure includes any of the preceding aspects, and the AM combustor body includes an aft frame at an aft end of the tapered transition portion and an impingement flow sleeve surrounding the tapered transition portion; wherein the resonating chamber is on an outside of one of the tapered transition portion adjacent the aft frame and the impingement flow sleeve; and wherein an impingement annulus is defined between the impingement flow sleeve and the tapered transition portion of the combustion liner, and the resonating tube neck includes a second end in fluid communication with the combustion chamber in the combustion liner.

Another aspect of the disclosure includes any of the preceding aspects, and a portion of the resonating chamber is within the aft frame.

Another aspect of the disclosure includes any of the preceding aspects, and further comprising an impingement annulus defined in one of the tapered transition portion of the combustion liner and between an impingement flow sleeve and the tapered transition portion of the combustion liner; and wherein the resonating chamber is on an outside of the impingement annulus, and the resonating tube neck includes a second end in fluid communication with the impingement annulus.

Another aspect of the disclosure includes any of the preceding aspects, and the resonating tube is one of at least two resonating tubes, and at least one of the two resonating tubes includes: (a) a resonating chamber disposed on an outside of an annulus surrounding at least part of the combustion liner, the annulus defined by one of a flow sleeve surrounding the combustion liner or an annular passage in at least part of the combustion liner, and wherein the resonating tube neck includes a second end in fluid communication with the annulus; (b) a resonating chamber disposed on an outside of the annulus, and wherein the resonating tube neck includes a second end in fluid communication with the combustion chamber defined by the combustion liner; (c) a resonating chamber disposed within the annulus, and wherein the resonating tube neck includes a second end in fluid communication with the combustion chamber; (d) a resonating chamber spaced outside of the annulus by the resonating tube neck, and wherein the resonating tube neck includes a second end in fluid communication with the annulus; (e) a resonating chamber disposed on an outside of one of the tapered transition portion and an impingement flow sleeve surrounding the tapered transition portion; wherein the tapered transition portion includes an aft frame at an aft end of the tapered transition portion, and the resonating chamber is adjacent to the aft frame; and wherein an impingement annulus is defined between the tapered transition portion and the impingement flow sleeve, and the resonating tube neck includes a second end in fluid communication with the combustion chamber; (f) a resonating chamber at least partially disposed within the aft frame, and the resonating tube neck includes a second end in fluid communication with the combustion chamber; or (g) a resonating chamber disposed on an outside of the impingement annulus, and the resonating tube neck has a second end in fluid communication with the impingement annulus.

Another aspect of the disclosure includes any of the preceding aspects, and the at least two resonating tubes are configured to dampen different frequencies.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional side view of a portion of a combustor with an additively manufactured combustor body including a resonating tube according to embodiments of the disclosure;

FIG. 2 shows a cross-sectional side view of a portion of a combustor with an additively manufactured single wall combustor body including a resonating tube according to other embodiments of the disclosure;

FIG. 3 shows a cross-sectional view of a plurality of parallel, sintered metal layers of the combustor body according to embodiments of the disclosure;

FIG. 4 shows a cross-sectional view of a resonating tube according to embodiments of the disclosure;

FIG. 5 shows a cross-sectional view of a resonating tube in a combustor body according to other embodiments of the disclosure;

FIG. 6 shows a cross-sectional view of a resonating tube in a combustor body according to other embodiments of the disclosure;

FIG. 7 shows a cross-sectional view of a resonating tube in a combustor body according to yet other embodiments of the disclosure;

FIG. 8 shows a cross-sectional view of a resonating tube in a combustor body according to additional embodiments of the disclosure;

FIG. 9 shows a cross-sectional view of a resonating tube in a combustor body according to further embodiments of the disclosure;

FIG. 10 shows a functional block diagram of an illustrative gas turbine system capable of use with a combustor and combustor body including a resonating tube according to the various embodiments of the disclosure; and

FIG. 11 shows a schematic block diagram of an illustrative additive manufacturing system for additively manufacturing a combustor body including a resonating tube according to the various embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current technology, it will become necessary to select certain terminology when referring to and describing relevant machine components within the illustrative application of a turbomachine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through a combustor of the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine. The term “axial” refers to movement or position parallel to an axis, e.g., an axis of a combustor or turbomachine. The term “radial” refers to movement or position perpendicular to an axis, e.g., an axis of a combustor or a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a combustion liner or a circumferential interior of casing extending about a combustor. As indicated above and depending on context, it will be appreciated that such terms may be applied in relation to the axis of the combustor or the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur, or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” “directly coupled to,” or “directly mounted to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure provide a combustor for a gas turbine system. The combustor includes an additively manufactured (AM) combustor body including a one-piece member. The one-piece member includes a combustion liner including a cylindrical portion and a tapered transition portion and that may optionally include an aft frame at an aft end of the tapered transition portion. A resonating tube is part of the AM combustor body and is configured to dampen acoustic pressure oscillations of combustion gases in the combustor. The AM combustor body includes a plurality of parallel, sintered metal layers. The resonating tube includes a body defining a resonating chamber and a resonating tube neck having a first end in fluid communication with the resonating chamber. A second end of the resonating tube is in fluid communication with an annulus (air flow passage) or with the combustion chamber. The additive manufacturing enables formation of the AM combustor body as single body and lowers the costs of the combustor body by eliminating numerous parts and many of the required assembly steps. The AM combustor body also provides a low-cost resonator along a length of the combustion liner where normally it is very expensive and complicated to install. The AM process allows for easy alteration and testing of different solutions.

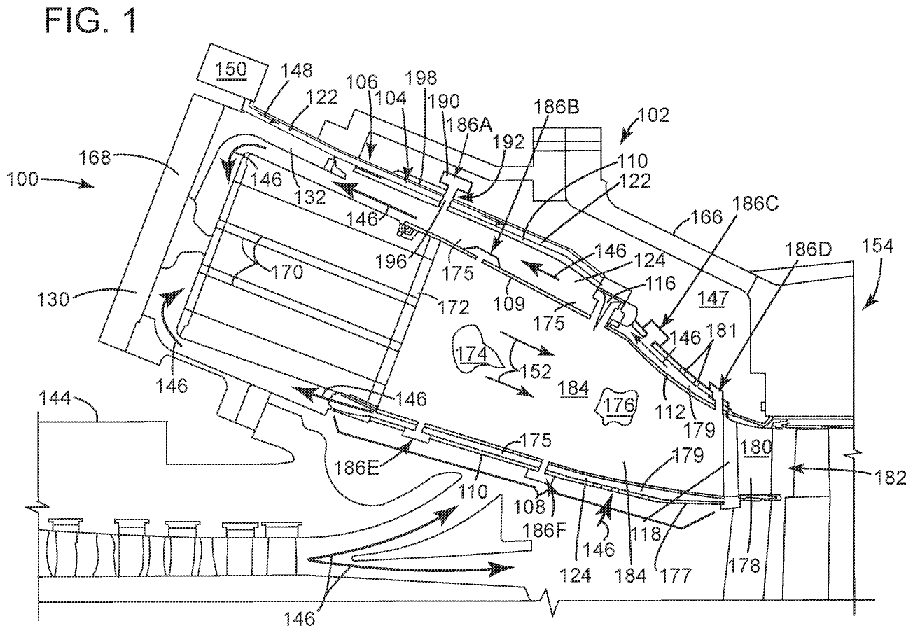

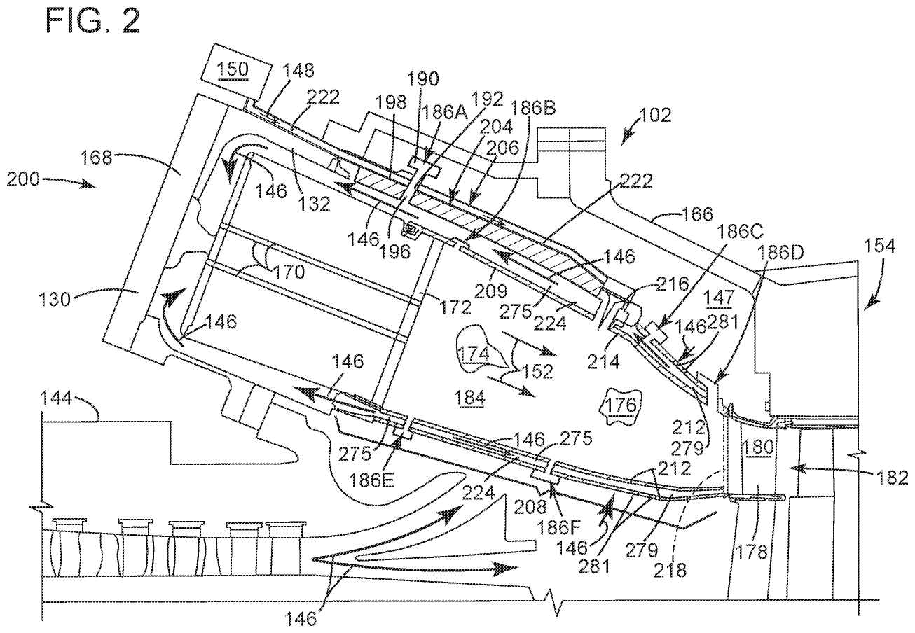

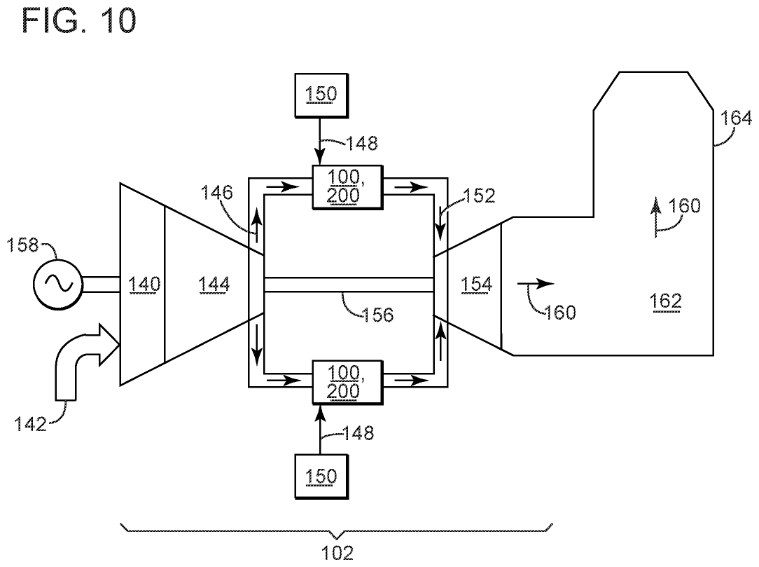

FIGS. 1 and 2 show cross-sectional side views of portions of combustors 100, 200 that may use a resonating tube 186 according to embodiments of the disclosure. FIGS. 1 and 2 will be initially used to describe illustrative parts of combustors 100, 200. Operation of combustors 100, 200 as part of a gas turbine system 102 will be described later herein relative to FIG. 10.

FIG. 1 shows a cross-sectional side view of a portion of a combustor 100 (positioned within a gas turbine (GT) system 102) that may use a resonating tube 186A-F (collectively referenced as resonating tube 186) according to embodiments of the disclosure. As shown in FIG. 1, combustor 100 for GT system 102 includes an additively manufactured combustor body 104 including a one-piece member 106 including a combustion liner 108 including a cylindrical portion 109 and a tapered transition portion 112, which collectively define a combustion chamber 184. In some embodiments, an aft frame 118 at an aft end of tapered transition portion 112 of combustion liner 108 may also be formed as part of the additively manufactured combustor body 104. Combustor 100 also includes one or more resonating tubes 186 configured to dampen acoustic pressure oscillations of combustion gases 152 flowing in combustion chamber 184 of combustor 100. Resonating tubes 186 may be alternatively known as Helmholtz dampers or resonators. Combustor body 104 also may include at least one axial fuel stage (AFS) injector 116 directed into combustion liner 108. Embodiments of the disclosure may also include a flow sleeve 110 that surrounds at least part of combustion liner 108 and that may be formed integrally with the combustor body 104.

In certain embodiments, AM combustor body 104 further includes at least one fuel passage 122 extending longitudinally along flow sleeve 110 from a forward end thereof to AFS injector(s) 116. Fuel passage(s) 122 may be defined in external fuel lines mounted to combustor body 104 or may be integrally formed in flow sleeve(s) 110 and thus in combustor body 104, eliminating the need for separate fuel lines mounted to combustor body 104. AM combustor body 104 may further include a plurality of flow passages 124, e.g., air cooling passages, extending at least partially longitudinally in combustion liner 108, e.g., in cylindrical portion 109 thereof. In some embodiments, flow passages 124 may be defined between cylindrical portion 109 and flow sleeve 110 or between transition portion 112 and aft flow sleeve 110. Flow passages 124 may be annular or discrete passages.

FIG. 2 shows a cross-sectional side view of a portion of a combustor 200 (positioned within a gas turbine (GT) system 102) that may use a resonating tube 186 according to other embodiments of the disclosure. This embodiment is substantially similar to the FIG. 1 embodiment, except a combustion liner 208 is a unitary structure, and any separate flow sleeves are omitted. As shown in FIG. 2, combustor 200 for GT system 102 includes an additively manufactured combustor body 204 including one-piece member 206 including a combustion liner 208 including a cylindrical portion 209 and a tapered transition portion 212 at an aft end 214 of cylindrical portion 209, which collectively define a combustion chamber 184. In some embodiments, an aft frame 218 at an aft end of tapered transition portion 212 may also be formed as part of the additively manufactured combustor body 204. Combustor body 204 may also include at least one axial fuel stage (AFS) injector 216 directed into combustion liner 208.

In certain embodiments, AM combustor body 204 further includes at least one fuel passage 222 extending longitudinally in AM combustor body 204 from a forward end thereof to AFS injector(s) 216, e.g., in cylindrical portion 209. Fuel passage(s) 222 are integrally formed in unitary combustor body 204, i.e., in a radially outer section of cylindrical portion 209 of combustion liner 108. AM combustor body 204 may further include a plurality of flow passages 224, e.g., air cooling passages, extending at least partially longitudinally in combustion liner 208 between the radially outer section and a radially inner section that defines combustion chamber 184.

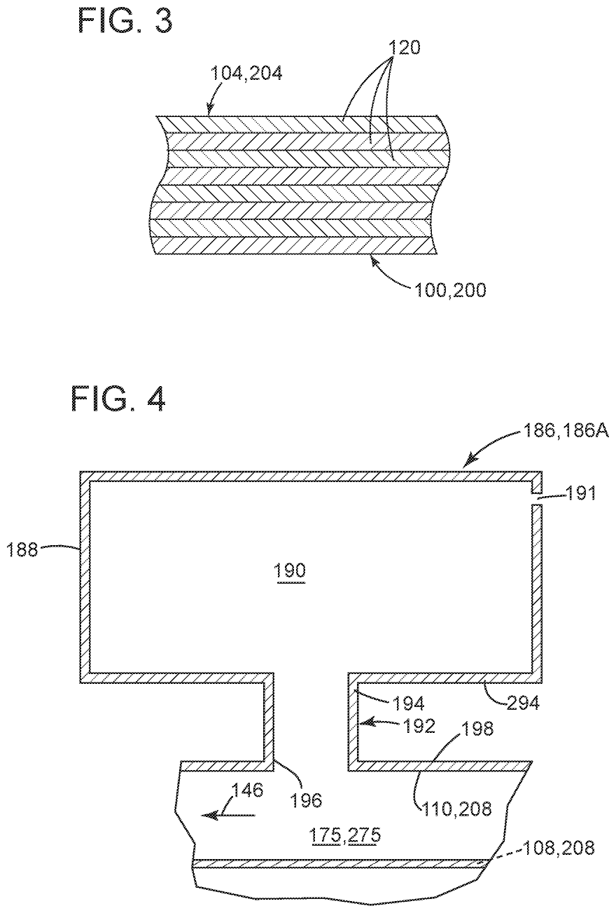

As a result of the additive manufacturing, there are no mechanical connections in combustor body 104 or 204 between the various recited parts (that is, they are one-piece). FIG. 3 shows a schematic cross-sectional view of any portion of additively manufactured combustor body 104, 204 (hereafter “AM combustor body 104, 204” or “combustor body 104, 204”). As shown in FIG. 3, AM combustor body 104, 204 includes a plurality of parallel, sintered metal layers 120, e.g., resulting from the additive manufacturing thereof.

As shown in FIGS. 1 and 2, combustor 100, 200 may include a separate head end fuel nozzle assembly 130 (hereafter “head end assembly 130”) coupled to a forward end 132 of AM combustor body 104, 204. “Separate” indicates head end assembly 130 is not additively manufactured with combustor body 104, 204. Head end assembly 130 may include any now known or later developed fuel nozzle assembly for delivering fuel 148 to a primary combustion zone 174 from axially extending fuel nozzles 170. AFS injector(s) 116, 216 may include any now known or later developed axial fuel stage injectors for delivering fuel 148 to a secondary combustion zone 176.

Combustor body 104, 204 may also include an annulus 175, 275 surrounding at least part of combustion liner 108, 208 (can also be flow passage 124, 224). Annulus 175, 275 may be used for directing air 146 to cool combustion liner 108, 208 and/or for combustion, e.g., in head end assembly 130 or AFS injectors 116, 216. As shown in FIG. 1, annulus 175, 275 may be defined by, or radially outward of, a flow sleeve 110 (FIG. 1) surrounding the at least part of combustion liner 108, or, as shown in FIG. 2, an annular passage (annulus 275) may be defined in at least part of combustion liner 208 (i.e., a radially outer part).

As shown in FIG. 1, combustor body 104 may also include an impingement flow sleeve 177 surrounding tapered transition portion 112 of combustion liner 108 and defining an impingement annulus 179 between impingement flow sleeve 177 and tapered transition portion 112 of combustion liner 108. Alternatively, as shown in FIG. 2, combustor body 204 may include an impingement annulus 279 defined in tapered transition portion 212 of combustion liner 208, i.e., integrally formed during additive manufacturing between a radially inner part of the transition portion 212 and a radially outer part of the transition portion 212. Impingement flow sleeve 177 or tapered transition piece 212 may include a plurality of holes 181, 281 to allow air 146 from an air supply 147, e.g., air within casing 166 provided from compressor 144 discharge, to enter impingement annulus 179, 279 and cool tapered transition piece 112, 212 (and provide air for combustion with AFS injectors 116, 216).

While FIGS. 1 and 2 show illustrative combustors 100, 200 that can use resonating tubes 186 according to embodiments of the disclosure, resonating tubes 186 can be used in any combustor requiring dampening of acoustics. Accordingly, combustors 100, 200 are merely examples, and other combustor assemblies may benefit from the present resonating tubes 186.

Turning to details of resonating tubes 186, FIG. 4 shows a cross-sectional view of an illustrative resonating tube 186, e.g., resonating tube 186A in FIGS. 1 and 2, for description of general structure of each resonating tube 186. As shown in FIG. 4, resonating tube(s) 186 includes a body 188 defining a resonating chamber 190 and a resonating tube neck 192 having a first end 194 in fluid communication with resonating chamber 190. Resonating tube neck 192 also includes a second end 196 which, as will be described, can be in fluid communication with different fluid chambers, e.g., annulus 175, 275 or combustion chamber 184. A shape and/or size of resonating chamber 190 and/or neck 192 can vary depending on tube 186 location and the acoustics to be dampened. For example, the internal damping volume of each resonating chamber 190 can be sized and/or shaped for specific acoustic damping frequencies. Generally, resonating chamber 190 will have a greater width and area than neck 192.

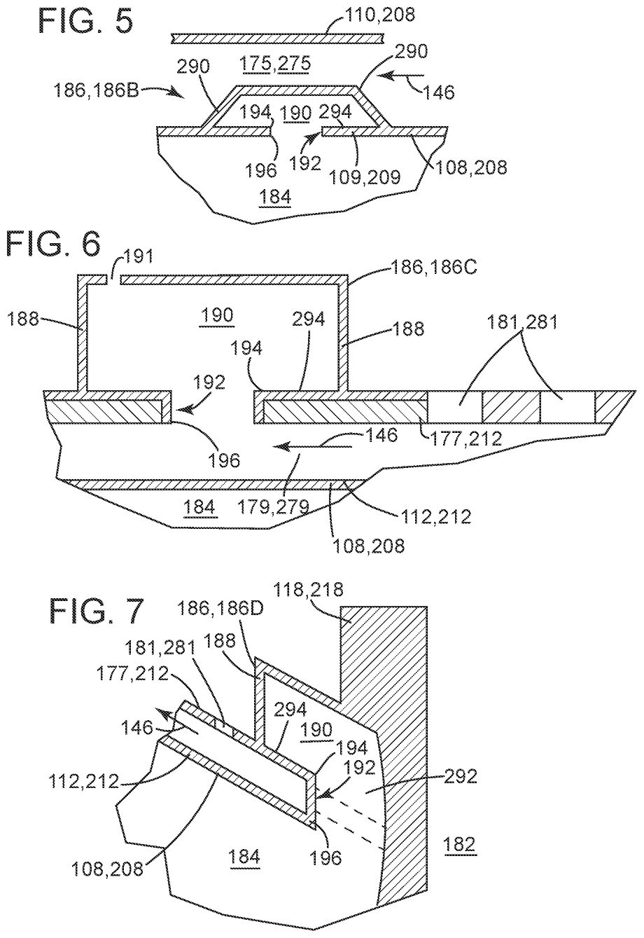

While not necessary in all cases, as shown in FIGS. 4, 6 and 8 for illustrative embodiments, any resonating chamber 190 described herein may have purge holes 191 that provide fluid communication between air supply 147 and resonating chamber 190. In particular, purge holes 191 can increase cooling, but in other embodiments, shown for example in FIGS. 5, 7 and 9, purge holes 191 may be absent to eliminate fluid communication. When present, purge holes 191 provide an increased cooling effect because cooling air 146 enters into resonating chamber 190 from air supply 147 via purge holes 191 and cools the damping volume inside resonating chamber 190. The cooled damping volume then flows out from resonating chamber 190 through resonating tube neck 192 into annulus 175, 275 or combustion chamber 184. Purge holes 191 may also assist in removing un-sintered metal powder after additive manufacturing and before operation of combustor 100, 200.

Resonating tube(s) 186 may be used in wide variety of different arrangements and locations on combustion liner 108, 208, some examples of which are shown as resonating tubes 186A-F in FIGS. 1-2. FIGS. 4-9 show more detailed cross-sectional views of each resonating tube 186A-F.

As shown in FIGS. 1, 2 and 4, resonating chamber 190 of resonating tube 186A is spaced from an outside 198 of annulus 175, 275 by resonating tube neck 192, and second end 196 of resonating tube neck 192 is in fluid communication with annulus 175, 275. As noted, annulus 175 can be formed by flow sleeve 110 spaced from combustion liner 108 (dashed line), or annulus 275 can be formed in combustion liner 208.

As shown in FIGS. 1, 2 and 5, resonating tube 186B is positioned in annulus 175, 275, i.e., chamber 190 is in annulus 175, 275. First end 194 of resonating tube neck 192 is in fluid communication with resonating chamber 190, and second end 196 of resonating tube neck 192 is in fluid communication with combustion chamber 184 in combustion liner 108, 208. Body 188 of resonating tube 186B may have angled side walls 290 such that resonating chamber 190 is trapezoidal in cross-section to reduce drag or interference of flow of compressed air 146 in annulus 175, 275. Although shown in FIGS. 1, 2 and 5 as being installed on cylindrical portion 109, 209 of combustion liner 108, 208, it should be understood that resonating tube 186B may instead or additionally be installed on tapered transition portion 112, 212.

As shown in FIGS. 2 and 6, impingement annulus 279 is defined in tapered transition portion 212 of combustion liner 208 (additively manufactured therein), or as shown in FIGS. 1 and 6, impingement annulus 179 is defined between impingement flow sleeve 177 and tapered transition portion 112 of combustion liner 108. For resonating tube 186C, resonating chamber 190 is on an outside of impingement annulus 179, 279. That is, as shown in FIG. 2, resonating chamber 190 is on outside of tapered transition portion 212 with impingement annulus 279 therein, or as shown in FIG. 1, resonating chamber 190 is on outside of flow sleeve 177 where impingement annulus 179 is defined between flow sleeve 177 and tapered transition portion 112. In any event, resonating tube neck 192 for resonating tube 186C, which is formed through flow sleeve 177 or a radially outer part of tapered transition portion 212, includes first end 194 in fluid communication with resonating chamber 190 and second end 196 in fluid communication with impingement annulus 179, 279.

As shown in FIGS. 1, 2 and 7, resonating chamber 190 of resonating tube 186D is on an outside of tapered transition portion 212 adjacent aft frame 118 (FIGS. 2 and 7), or on impingement flow sleeve 177 surrounding tapered transition portion 112 of combustion liner 108 (FIGS. 1 and 7). As described above, impingement annulus 179 is defined between tapered transition portion 112 of combustion liner 108 and impingement flow sleeve 177. Alternately, as shown in FIG. 2, impingement annulus 279 is defined within tapered transition portion 212 (e.g., between a radially inner part and a radially outer part). In any event, resonating tube neck 192 of resonating tube 186D includes first end 194 in fluid communication with resonating chamber 190 and second end 196 in fluid communication with combustion chamber 184 defined by combustion liner 108, 208. That is, resonating tube neck 192 extends circumferentially across or around some portion or an entirety of a perimeter of impingement annulus 179, 279. In FIGS. 1 and 2, resonating chamber 190 of resonating tube 186D is adjacent aft frame 118, 218, i.e., body 188 thereof may be upstream of aft frame 118, 218 or may share an upstream wall of aft frame 118, 218. In other embodiments, as shown in FIG. 7, a portion 292 of resonating chamber 190 is within aft frame 118, 218.

As shown in FIGS. 1, 2 and 8, resonating tube 186E includes resonating chamber 190 on an outside of annulus 175, 275. Resonating tube neck 192 includes first end in communication with resonating chamber 190 and second end 196 in fluid communication with combustion chamber 184 defined by combustion liner 108, 208. Resonating tube neck 192 extends across annulus 175, 275. In this embodiment, resonating chamber 190 is partially defined by flow sleeve 110 or combustion liner 208, such that flow sleeve 110 or combustion liner 208 form radially inner wall 294 of body 188 of resonating tube 186E.

As shown in FIGS. 1, 2 and 9, resonating chamber 190 of resonating tube 186F is on an outside of annulus 175, 275. Resonating tube neck 192 includes first end in fluid communication with resonating chamber 190 and second end 196 in fluid communication with annulus 175, 275.

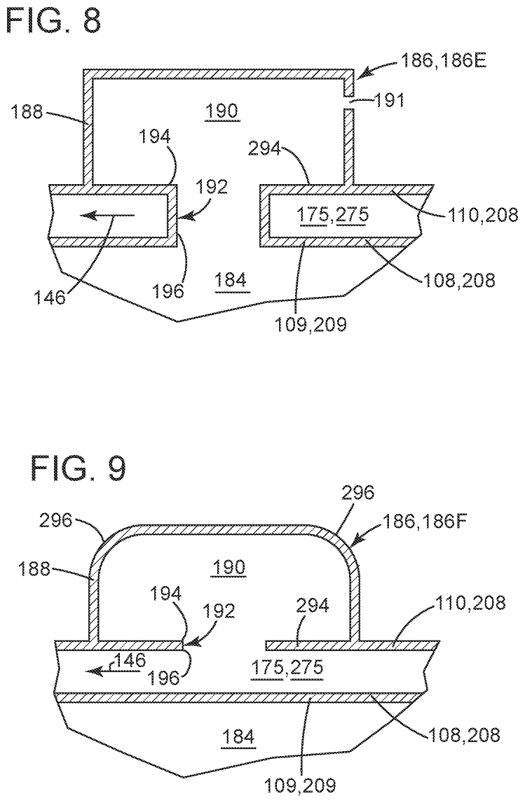

As shown in FIGS. 5 and 7-9, a (radially) inner wall 294 of body 188 of resonating tubes 186B, D-F and/or part of resonating tube neck 192 may be formed or shared with structure of combustor body 104, 204 (FIGS. 1-2) in which resonating tubes 186 are adjacent. For example, FIG. 5 shows inner wall 294 integral (and perhaps coplanar) with cylindrical portion 109, 209 of combustion liner 108, 208; FIG. 7 shows inner wall 294 integral (and perhaps coplanar) with flow sleeve 177 or tapered transition portion 212 of combustion liner 108 or 208, respectively; and FIGS. 8 and 9 show inner wall 294 integral (and perhaps coplanar) with flow sleeve 110 (FIG. 1) or outer portion of combustion liner 208 (FIG. 2). In other embodiments, as shown in FIG. 6, inner wall 294 may be a separate layer(s) of material, e.g., sintered metal layers, that make a thicker wall with whatever other structure of combustor body 104, 204 with which resonating tubes 186 are adjacent. In FIG. 6, inner wall 294 is shown as a separate layer or a thicker layer with a portion of impingement sleeve 177 (FIG. 1) or tapered transition portion 212 (FIG. 2).

It is emphasized that resonating chamber 190 and/or resonating tube neck 192 may have any cross-sectional shapes and dimensions desired to dampen acoustic pressure oscillations of combustion gases 152 flowing in combustor 100, 200. For example, while resonating chamber 190 is shown mostly having a rectangular cross-section, it may have any shape. For example, FIG. 5 shows resonating chamber 190 with a trapezoidal cross-section, and FIG. 9 shows resonating chamber 190 with rounded corners 296. Other shapes are also possible for resonating chamber 190 and/or neck 192. The shapes may also vary as they extend circumferentially around combustor body 104, 204, i.e., into or out of page as shown in the drawings. Resonating tube 186 may have any width in the circumferential direction up to and including a full annulus.

Resonating tube neck 192 may have any dimensions (e.g., length and diameter). As shown in FIG. 4, resonating tube neck 192 may have a sufficient length to extend radially outward of flow sleeve 110. Alternatively, as shown in FIGS. 5 and 9, resonating tube neck 192 may have a length equal to the thickness of flow sleeve 110 or combustion liner 208 portion within which resonating tube 186 is integrated. As yet another alternative, shown in FIGS. 6, 7, and 8, resonating tube neck 192 may have a length equal or approximately equal to the distance between combustion liner 108 and flow sleeve 110 or between the radially inner portion and the radially outer portion of combustion liner 208 (that is, a length that spans annulus 175, 275). While a single resonating tube neck 192 is shown, it should be understood that additional resonating tube necks 192 may be used in fluid communication with resonating chamber 190, particularly in those embodiments in which resonating tube 186 has a significant width in the circumferential direction.

It is noted that FIGS. 1 and 2 show six different types of resonating tubes 186A-F and six different locations for resonating tubes 186A-F together for illustration purposes only. In operation, any number of resonating tubes 186A-F may be used, e.g., one, two, three, four, five, six, or more than six. That is, not all six types and locations of resonating tubes 186A-F shown in FIGS. 1-2 need to be used together. Indeed, in most cases, only one form of resonating tube 186A-F would be used, e.g., in one axial location. The different types of resonating tubes 186A-F may be used alone or in any combination. In certain embodiments, at least two resonating tubes are used, and at least one of the two resonating tubes includes, as described herein: (a) a resonating chamber disposed on an outside of an annulus surrounding at least part of the combustion liner, the annulus defined by one of a flow sleeve surrounding the combustion liner or an annular passage in at least part of the combustion liner, and wherein the resonating tube neck includes a second end in fluid communication with the annulus; (b) has a resonating chamber disposed on an outside of the annulus, and wherein the resonating tube neck includes a second end in fluid communication with the combustion chamber defined by the combustion liner; (c) a resonating chamber disposed within the annulus, and wherein the resonating tube neck includes a second end in fluid communication with the combustion chamber; (d) a resonating chamber spaced outside of the annulus by the resonating tube neck, and wherein the resonating tube neck includes a second end in fluid communication with the annulus; (e) a resonating chamber disposed on an outside of one of the tapered transition portion and an impingement flow sleeve surrounding the tapered transition portion; wherein the tapered transition portion includes an aft frame at an aft end of the tapered transition portion, and the resonating chamber is adjacent to the aft frame; and wherein an impingement annulus is defined between the tapered transition portion and the impingement flow sleeve, and the resonating tube neck includes a second end in fluid communication with the combustion chamber; (f) resonating chamber at least partially disposed within the aft frame, and the resonating tube neck includes a second end in fluid communication with the combustion chamber; or (g) a resonating chamber disposed on an outside of the impingement annulus, and the resonating tube neck has a second end in fluid communication with the impingement annulus. Where at least two resonating tubes are provided, they may be configured to dampen different frequencies. Further, any number of resonating tubes 186 may be used circumferentially around combustion liner 108, 208, i.e., into and out of page of FIGS. 1 and 2, or in a circumferential array of discrete resonating tubes 186.

With reference to FIGS. 1 and 2, the arrangement and operation of combustor 100, 200 within GT system 102 will be described. FIG. 10 shows a functional block diagram of an illustrative GT system 102 that may incorporate various embodiments of combustor 100, 200 of the present disclosure. As shown, GT system 102 generally includes an inlet section 140 that may include a series of filters, cooling coils, moisture separators, and/or other devices to purify and otherwise condition a working fluid (e.g., air) 142 entering GT system 102. Working fluid 142 flows to a compressor section where a compressor section 144 progressively imparts kinetic energy to working fluid 142 to produce a compressed air 146 at a highly energized state. Compressed air 146 is mixed with a fuel 148 from a fuel supply 150 to form a combustible mixture within one or more combustors 100, 200. Combustion liner 108, 208 of combustors 100, 200 may contain and convey combustion gases 152 to a turbine section. Combustion liner 108, 208 defines a combustion chamber 184 within which combustion occurs. As shown in FIGS. 1 and 2, combustion liner 108, 208 may extend between head end assembly 130 and aft frame 118, 218. Combustion liner 108, 208 may have cylindrical portion 109, 209 and tapered transition portion 112, 212 integral with cylindrical portion 109, 209, i.e., forming a unified body (or “unibody”) construction.

The combustible mixture is burned to produce combustion gases 152 having a high temperature and pressure. Combustion gases 152 flow through a turbine 154 (e.g., an expansion turbine) of a turbine section to produce work. For example, turbine 154 may be connected to a shaft 156 so that rotation of turbine 154 drives compressor section 144 to produce compressed air 146. Alternately, or in addition, shaft 156 may connect turbine 154 to a generator 158 for producing electricity. Exhaust gases 160 from turbine 154 flow through an exhaust section 162 that connects turbine 154 to an exhaust stack 164 downstream from turbine 154. Exhaust section 162 may include, for example, a heat recovery steam generator (not shown) for cleaning and extracting additional heat from exhaust gases 160 prior to release to the environment.

In one embodiment, GT system 102 may include a commercially available model from GE Vernova of Cambridge, MA. The present disclosure is not limited to any one particular GT system and may be implanted in connection with other engines including, for example, the HA, F, B, LM, GT, TM and E-class engine models of GE Vernova, and engine models of other companies. Furthermore, the present disclosure is not limited to any particular turbomachine and may be applicable to, for example, steam turbines, jet engines, compressors, turbofans, etc.

As shown in FIGS. 1 and 2, combustor 100, 200 is at least partially surrounded by an outer casing 166 such as a compressor discharge casing and/or a turbine casing. Outer casing 166 is in fluid communication with compressor 144, which causes compressed air 146 to enter combustor body 104, 204 in various locations. An end cover 168 of head end assembly 130 is coupled to casing 166 at one end of combustor 100, 200. Head end assembly 130 generally includes at least one axially extending fuel nozzle 170 that extends downstream from end cover 168 and a cap assembly 172 that extends radially and axially within combustion liner 108, 208 downstream from end cover 168 to define the forward boundary of combustion chamber 184. In certain embodiments, axially extending fuel nozzle(s) 170 extend at least partially through cap assembly 172 to provide a combustible mixture of fuel and compressed air 146 to primary combustion zone 174 that is downstream from fuel nozzle(s) 170 to form combustion gases 152.

Combustion liner 108, 208, also known as a hot gas path duct or unibody liner, extends downstream from cap assembly 172. In certain embodiments, as shown in FIG. 1, annular flow sleeve(s) 110 may at least partially surround at least a portion of combustion liner 108, e.g., cylindrical portion 109 and/or tapered transition portion 112. In other embodiments, shown in FIG. 2, flow sleeves are omitted and a unitary combustion liner 208 is used. In some embodiments, AFS injectors 116, 216 extend through liner 108, 208 downstream from axially extending fuel nozzle(s) 170. In these embodiments, AFS injectors 116, 216 provide a combustible mixture of fuel 148 and compressed air 146 to secondary combustion zone 176 that is downstream from primary combustion zone 174 to form combustion gases 152.

In certain embodiments, as shown in FIG. 1, flow sleeve(s) 110 defines annulus 175, i.e., a flow passage, for routing compressed air 146 across an outer surface of combustion liner 108 (cylindrical portion 109 and/or tapered transition portion 112). In addition, flow sleeve(s) 110 may route at least a portion of compressed air 146 to the one or more radially extending AFS injectors 116 to combine with fuel for combustion in a secondary combustion zone 176 that is downstream from primary combustion zone 174. In addition, as shown in FIG. 1, fuel passages 122 in flow sleeve(s) 110 may deliver fuel to AFS injectors 116 from fuel supply 150. In other embodiments, as shown in FIG. 2, combustion liner 208 (cylindrical portion 209 and/or tapered transition portion 212) may define annulus 275 for routing compressed air 146 within combustion liner 208 (cylindrical portion 209 and/or tapered transition portion 212). In addition, as shown in FIG. 2, fuel passages 222 in combustion liner 208 (forward end thereof) may deliver fuel to AFS injectors 116 from fuel supply 150.

Regardless of combustor embodiment, combustor 100, 200 generally terminates at a point that is adjacent to a first stage 178 of stationary nozzles 180 of turbine 154. First stage 178 of stationary nozzles 180 at least partially defines a turbine inlet 182 to turbine 154. As noted, combustion liner 108, 208 at least partially defines combustion chamber 184 for routing combustion gases 152 from primary combustion zone 174 and secondary combustion zone 176 to turbine inlet 182 of turbine 154 during operation of GT system 102.

In operation, compressed air 146 flows from compressor 144 and is routed through annulus 175, 275. A portion of compressed air 146 is routed to head end assembly 130 of combustor 100, 200 where it reverses direction and is directed through axially extending fuel nozzle(s) 170. Compressed air 146 is mixed with fuel to form a first combustible mixture that is injected into primary combustion zone 174. The first combustible mixture is burned to produce combustion gases 152. A second portion of compressed air 146 may be routed through the radially extending AFS injectors 116, 216 where it is mixed with fuel 148 from fuel passages 122 in flow sleeve(s) 110 (FIG. 1) or fuel passages 222 in combustion liner 208 (FIG. 2) or fuel passages radially outboard of such structures (not shown) to form a second combustible mixture. The second combustible mixture is injected through liner 108, 208 and into combustion chamber 184. The second combustible mixture at least partially mixes with combustion gases 152 and is burned in secondary combustion zone 176. Liner 108, 208 defines combustion chamber 184 for routing combustion gases 152 from primary combustion zone 174 and secondary combustion zone 176 to turbine inlet 182 of turbine 154 during operation of GT system 102. During operation, one or more resonating tubes 186 dampen acoustic pressure oscillations of combustion gases in combustor 100, 200.

Combustor body 104, 204, including resonating tubes 186, may be additively manufactured using any now known or later developed technique capable of forming the large, integral body. In certain embodiments, as shown in FIG. 3, combustor body 104, 204 includes a plurality of parallel, sintered metal layers 120. The material for combustor body 104, 204 may include any now known or later developed combustion tolerant and oxidation resistant materials such as but not limited to: a nickel-chromium-cobalt-molybdenum alloy (NiCrCoMo) (e.g., HA282 or HA233 from Haynes International, Inc.), a nickel-chromium-molybdenum-niobium alloy (NiCrMoNb) (e.g., Inconel 625 or 718), a nickel-chromium-iron-molybdenum alloy (NiCrFeMo) (e.g., Hastelloy X available from Haynes International, Inc.), or a nickel-chromium-cobalt-titanium (NiCrCoTi) alloy (e.g., GTD 262 developed by General Electric Company).

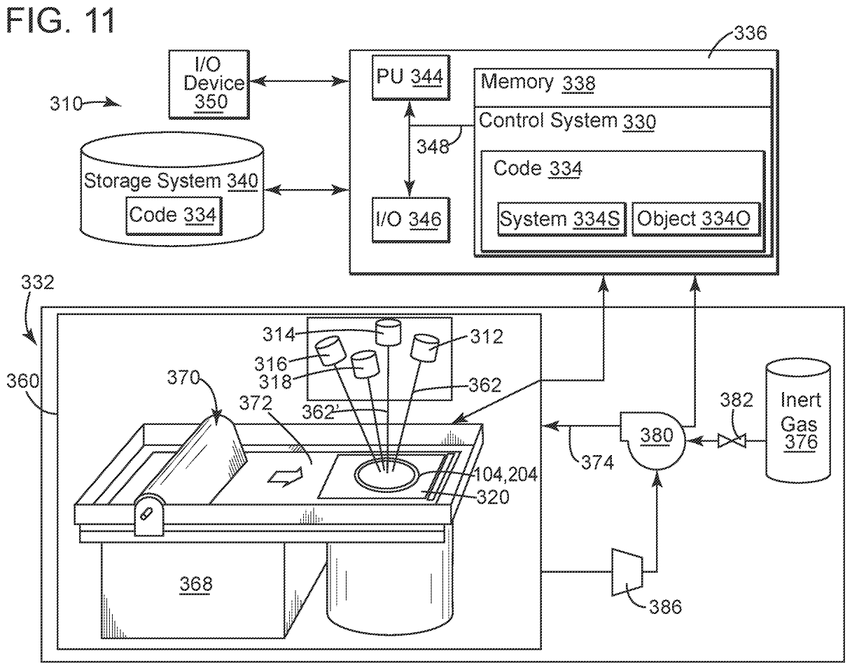

FIG. 11 shows a schematic/block view of an illustrative computerized metal powder additive manufacturing system 310 (hereinafter ‘AM system 310’) for generating combustor body 104, 204, of which only a single layer is shown. Combustor body 104, 204 and resonating tube(s) 186 can be made advantageously as an integral unitary piece. The teachings of the disclosures will be described relative to building combustor body 104, 204 using multiple melting beam sources 312, 314, 316, 318, but it is emphasized and will be readily recognized that the teachings of the disclosure are equally applicable to build combustor body 104, 204 using any number of melting beam sources.

In this example, AM system 310 is arranged for direct metal laser melting (DMLM). It is understood that the general teachings of the disclosure are equally applicable to other forms of metal powder additive manufacturing such as but not limited to selective laser melting (SLM), and perhaps other forms of additive manufacturing (i.e., other than metal powder applications). The layer of combustor body 104, 204 in build platform 320 is illustrated in FIG. 11 as a circular element; however, it is understood that the additive manufacturing process can be readily adapted to manufacture any shaped part of combustor body 104, 204 on build platform 320.

AM system 310 generally includes an additive manufacturing control system 330 (“control system”) and an AM printer 332. As will be described, control system 330 executes set of computer-executable instructions or code 334 to generate combustor body 104, 204 using multiple melting beam sources 312, 314, 316, 318. In the example shown, four melting beam sources may include four lasers. However, the teachings of the disclosures are applicable to any melting beam source, e.g., an electron beam, laser, etc. Control system 330 is shown implemented on computer 336 as computer program code. To this extent, computer 336 is shown including a memory 338 and/or storage system 340, a processor unit (PU) 344, an input/output (I/O) interface 346, and a bus 348. Further, computer 336 is shown in communication with an external I/O device/resource 350.

In general, processor unit (PU) 344 executes computer program code 334 that is stored in memory 338 and/or storage system 340. While executing computer program code 334, processor unit (PU) 344 can read and/or write data to/from memory 338, storage system 340, I/O device 350 and/or AM printer 332. Bus 348 provides a communication link between each of the components in computer 336, and I/O device 350 can comprise any device that enables a user to interact with computer 336 (e.g., keyboard, pointing device, display, etc.).

Computer 336 is only representative of various possible combinations of hardware and software. For example, processor unit (PU) 344 may comprise a single processing unit or be distributed across one or more processing units in one or more locations, e.g., on a client and server. Similarly, memory 338 and/or storage system 340 may reside at one or more physical locations. Memory 338 and/or storage system 340 can comprise any combination of various types of non-transitory computer readable storage medium including magnetic media, optical media, random access memory (RAM), read only memory (ROM), etc. Computer 336 can comprise any type of computing device such as an industrial controller, a network server, a desktop computer, a laptop, a handheld device, etc.

As noted, AM system 310 and, in particular control system 330, executes code 334 to generate combustor body 104, 204, including resonating tube(s) 186. Code 334 can include, among other things, a set of computer-executable instructions 334S (herein also referred to as ‘code 334S’) for operating AM printer 332 as a system, and a set of computer-executable instructions 334O (herein also referred to as ‘code 334O’) for defining respective objects, such as combustor body 104, 204 with resonating tube(s) 186, to be physically generated by AM printer 332. As described herein, additive manufacturing processes begin with a non-transitory computer readable storage medium (e.g., memory 338, storage system 340, etc.) storing code 334. Set of computer-executable instructions 334S for operating AM printer 332 may include any now known or later developed software code capable of operating AM printer 332.

The set of computer-executable instructions 334O defining combustor body 104, 204 with resonating tube(s) 186 may include a precisely defined 3D model of combustor body 104, 204 and resonating tube(s) 186 and can be generated from any of a large variety of well-known computer aided design (CAD) software systems such as AutoCAD®, TurboCAD®, DesignCAD 3D Max, etc. In this regard, code 334O can include any now known or later developed file format. Furthermore, code 334O representative of combustor body 104, 204 may be translated between different formats. For example, code 334O may include Standard Tessellation Language (STL) files, which were created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 334O representative of combustor body 104, 204 may also be converted into a set of data signals and transmitted, received as a set of data signals and converted to code, stored, etc., as necessary. Code 334O may be configured according to embodiments of the disclosure to allow for formation of border and internal sections in overlapping field regions, as will be described. In any event, code 334O may be an input to AM system 310 and may come from a part designer, an intellectual property (IP) provider, a design company, the operator or owner of AM system 310, or from other sources. In any event, control system 330 executes code 334S and 334O, dividing combustor body 104, 204 into a series of thin slices that assembles using AM printer 332 in successive layers of material.

AM printer 332 may include a processing chamber 360 that is sealed to provide a controlled atmosphere for combustor body 104, 204 printing. A build platform 320, upon which combustor body 104, 204 is/are built, is positioned within processing chamber 360. A number of melting beam sources 312, 314, 316, 318 are configured to melt layers of metal powder on build platform 320 to generate combustor body 104, 204. While four melting beam sources 312, 314, 316, 318 are illustrated, it is emphasized that the teachings of the disclosure are applicable to a system employing any number of sources, e.g., 1, 2, 3, or 5 or more. As understood in the field, each melting beam source 312, 314, 316, 318 may have a field including a non-overlapping field region, respectively, in which it can exclusively melt metal powder, and may include at least one overlapping field region in which two or more sources can melt metal powder. In this regard, each melting beam source 312, 314, 316, 318 may generate a melting beam, respectively, that fuses particles for each slice, as defined by code 334O.

For example, in FIG. 11, melting beam source 312 is shown creating a layer of combustor body 104, 204 using melting beam 362 in one region, while melting beam source 314 is shown creating a layer of combustor body 104, 204 using melting beam 362′ in another region. Each melting beam source 312, 314, 316, 318 is calibrated in any now known or later developed manner. That is, each melting beam source 312, 314, 316, 318 has had its laser or electron beam's anticipated position relative to build platform 320 correlated with its actual position in order to provide an individual position correction (not shown) to ensure its individual accuracy. In one embodiment, each of plurality melting beam sources 312, 314, 316, 318 may create melting beams, e.g., 362, 362′, having the same cross-sectional dimensions (e.g., shape and size in operation), power and scan speed.

Continuing with FIG. 11, an applicator (or re-coater blade) 370 may create a thin layer of raw material 372 spread out as the blank canvas from which each successive slice of the final combustor body 104, 204 will be created. Various parts of AM printer 332 may move to accommodate the addition of each new layer, e.g., a build platform 320 may lower and/or chamber 360 and/or applicator 370 may rise after each layer. The process may use different raw materials in the form of fine-grain metal powder, a stock of which may be held in a chamber or powder reservoir 368 accessible by applicator 370.

Processing chamber 360 is filled with an inert gas such as argon or nitrogen and controlled to minimize or eliminate oxygen. Control system 330 is configured to control a flow of a gas mixture 374 within processing chamber 360 from a source of inert gas 376. In this case, control system 330 may control a pump 380, and/or a flow valve system 382 for inert gas to control the content of gas mixture 374. Flow valve system 382 may include one or more computer controllable valves, flow sensors, temperature sensors, pressure sensors, etc., capable of precisely controlling flow of the particular gas. Pump 380 may be provided with or without valve system 382. Where pump 380 is omitted, inert gas may simply enter a conduit or manifold prior to introduction to processing chamber 360. Source of inert gas 376 may take the form of any conventional source for the material contained therein, e.g., a tank, reservoir or other source. Any sensors (not shown) required to measure gas mixture 374 may be provided. Gas mixture 374 may be filtered using a filter 386 in a conventional manner.

In operation, build platform 320 with metal powder thereon is provided within processing chamber 360, and control system 330 controls flow of gas mixture 374 within processing chamber 360 from source of inert gas 376. Control system 330 also controls AM printer 332, and in particular, applicator 370 and melting beam sources 312, 314, 316, 318 to sequentially melt layers of metal powder on build platform 320 to generate combustor body 104, according to embodiments of the disclosure. While a particular AM system 310 has been described herein, it is emphasized that the teachings of the disclosure are not limited to any particular additive manufacturing system or method.

Once combustor body 104, 204 is/are formed, as shown in FIG. 2, it may be assembled with other parts of combustor 100 and/or to turbine inlet 254. For example, head end assembly 130 may be coupled to a forward end of combustor body 104, 204. Head end assembly 130 may be coupled in any now known or later developed fashion, such as welding or fasteners. In addition, turbine inlet 182 may be coupled to aft frame 118, 218. Aft frame 118, 218 may be coupled to turbine inlet 182 in any now known or later developed fashion, such as welding or fasteners.

The disclosure provides various technical and commercial advantages, examples of which are discussed herein. The additive manufacturing enables formation of the AM combustor body as single body and lowers the costs of the combustor body by eliminating numerous parts and many of the required assembly steps. The AM combustor body also provides a low-cost resonator along a length of the combustion liner where normally it is very expensive and complicated to install. The AM process allows for easy alteration and testing of different solutions. Moreover, the resonating tubes may be designed to mitigate different dynamics frequencies within combustor 100, 200, and the AM process allows the resonating tubes (whether for one or multiple frequencies of concern) to be easily integrated into the combustor body without the need for separate fabrication and coupling, thus reducing assembly time and reducing inventory of individual resonating tubes.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

1. A combustor for a gas turbine system, the combustor comprising:
an additively manufactured (AM) combustor body including a one-piece member including:
a combustion liner defining a combustion chamber and including a cylindrical portion and a tapered transition portion; and
a resonating tube configured to dampen acoustic pressure oscillations of combustion gases in the combustor, the resonating tube including a body defining a resonating chamber and a resonating tube neck having a first end in fluid communication with the resonating chamber;
wherein the AM combustor body includes a plurality of parallel, sintered metal layers;
wherein at least part of the combustion liner is surrounded by a flow sleeve arranged to be radially between, in a radial direction of the combustor, the combustion liner and an outer casing of a gas turbine system when the combustor is installed therein;
wherein an annulus that is an annular flow passage is defined between the flow sleeve and the at least part of the combustion liner,
wherein the body defining the resonating chamber includes:
a first wall parallel to the combustion liner and outwardly spaced apart therefrom in the radial direction of the combustor, wherein the first wall is also radially inwardly spaced apart from an inner surface of the flow sleeve in the annular flow passage; and
a plurality of side walls that are positioned in the annulus and that extend at an acute angle from the combustion liner to the first wall of the body; and
wherein a second end of the resonating tube neck is in fluid communication with the combustion chamber.

2.-6. (canceled)

7. The combustor of claim 1, wherein the annulus is a first annulus and the flow sleeve is a first flow sleeve, wherein the AM combustor body includes an aft frame at an aft end of the tapered transition portion and an impingement flow sleeve surrounding the tapered transition portion, wherein the impingement flow sleeve is one of a second flow sleeve or a portion of the first flow sleeve; wherein the body defining the resonating chamber is on an outside of the tapered transition portion adjacent the aft frame; and wherein an impingement annulus is defined between the impingement flow sleeve and the tapered transition portion of the combustion liner, wherein the impingement annulus is one of a second annulus or a portion of the first annulus, and the resonating tube neck includes the second end in fluid communication with the combustion chamber defined by the combustion liner.

8. The combustor of claim 7, wherein a portion of the resonating chamber is within the aft frame.

9. (canceled)

10. The combustor of claim 1, wherein the resonating tube is one of at least two resonating tubes each including a respective body defining a respective resonating chamber and a respective resonating tube neck having a first end in fluid communication with the respective resonating chamber, wherein the annulus is a first annulus and the flow sleeve is a first flow sleeve, and wherein a configuration of at least one other of the at least two resonating tubes is selected from the following configurations:
(a) wherein the body defining the resonating chamber is disposed on an outside of the first annulus, and wherein the resonating tube neck includes a second end in fluid communication with the first annulus;
(b) wherein the body defining the resonating chamber is disposed on the outside of the first annulus, and wherein the resonating tube neck includes a second end in fluid communication with the combustion chamber defined by the combustion liner;
(c) wherein the body defining the resonating chamber is disposed within the first annulus, and wherein the resonating tube neck includes a second end in fluid communication with the combustion chamber;
(d) wherein the body defining the resonating chamber is spaced outside of the first annulus by the resonating tube neck, and wherein the resonating tube neck includes a second end in fluid communication with the first annulus;
(e) wherein the body defining the resonating chamber is disposed on an outside of one of the tapered transition portion and an impingement flow sleeve surrounding the tapered transition portion, wherein the impingement flow sleeve is one of a second flow sleeve or a portion of the first flow sleeve; wherein the tapered transition portion includes an aft frame at an aft end of the tapered transition portion, and the resonating chamber is adjacent to the aft frame; and wherein an impingement annulus is defined between the tapered transition portion and the impingement flow sleeve, wherein the impingement annulus is one of a second annulus or a portion of the first annulus, and the resonating tube neck includes a second end in fluid communication with the combustion chamber;
(f) wherein the body defining the resonating chamber is at least partially disposed within the aft frame, and the resonating tube neck includes a second end in fluid communication with the combustion chamber; or
(g) wherein the body defining the resonating chamber is disposed on an outside of the impingement annulus, and the resonating tube neck has a second end in fluid communication with the impingement annulus.

11. The combustor of claim 10, wherein the at least two resonating tubes are each configured to dampen different respective frequencies.

12. A gas turbine (GT) system, comprising:
a compressor section;
a combustion section operatively coupled to the compressor section;
a turbine section operatively coupled to the combustion section; and
an outer casing at least partially surrounding the combustion section;
wherein the combustion section includes a plurality of combustors, at least one combustor of the plurality of combustors including an additively manufactured (AM) combustor body including a one-piece member including:
a combustion liner defining a combustion chamber and including a cylindrical portion and a tapered transition portion; and
a resonating tube configured to dampen acoustic pressure oscillations of combustion gases in the combustor, the resonating tube including a body defining a resonating chamber and a resonating tube neck having a first end in fluid communication with the resonating chamber;
wherein the AM combustor body includes a plurality of parallel, sintered metal layers;
wherein at least part of the combustion liner is surrounded by a flow sleeve radially between, in a radial direction of the combustor, the combustion liner and the outer casing;
wherein an annulus that is an annular flow passage is defined between the flow sleeve and the at least part of the combustion liner;
wherein the body defining the resonating chamber includes:
a first wall parallel to the combustion liner and outwardly spaced apart therefrom in the radial direction of the combustor, wherein the first wall is also radially inwardly spaced apart from an inner surface of the flow sleeve in the annular flow passage; and
a plurality of side walls that are positioned in the annulus and that extend at an acute angle from the combustion liner to the first wall of the body; and
wherein a second end of the resonating tube neck is in fluid communication with the combustion chamber.

13.-17. (canceled)

18. The GT system of claim 12, wherein the annulus is a first annulus and the flow sleeve is a first flow sleeve, wherein the AM combustor body includes an aft frame at an aft end of the tapered transition portion and an impingement flow sleeve surrounding the tapered transition portion, wherein the impingement flow sleeve is one of a second flow sleeve or a portion of the first flow sleeve; wherein the body defining the resonating chamber is on an outside of the tapered transition portion adjacent the aft frame; and wherein an impingement annulus is defined between the impingement flow sleeve and the tapered transition portion of the combustion liner, wherein the impingement annulus is one of a second annulus or a portion of the first annulus, and the resonating tube neck includes the second end in fluid communication with the combustion chamber defined by the combustion liner.

19. The GT system of claim 18, wherein a portion of the resonating chamber is within the aft frame.

20. (canceled)

21. The GT system of claim 12, wherein the resonating tube is one of at least two resonating tubes each including a respective body defining a respective resonating chamber and a respective resonating tube neck having a first end in fluid communication with the respective resonating chamber, wherein the annulus is a first annulus and the flow sleeve is a first flow sleeve, and wherein a configuration of at least one other of the at least two resonating tubes is selected from the following configurations:
(a) wherein the body defining the resonating chamber is disposed on an outside of the first annulus surrounding at least part of the combustion liner, and wherein the resonating tube neck includes a second end in fluid communication with the first annulus;
(b) wherein the body defining the resonating chamber is disposed on an outside of the first annulus, and wherein the resonating tube neck includes a second end in fluid communication with the combustion chamber defined by the combustion liner;
(c) wherein the body defining the resonating chamber is disposed within the first annulus, and wherein the resonating tube neck includes a second end in fluid communication with the combustion chamber;
(d) wherein the body defining the resonating chamber is spaced outside of the first annulus by the resonating tube neck, and wherein the resonating tube neck includes a second end in fluid communication with the first annulus;
(e) wherein the body defining the resonating chamber is disposed on an outside of one of the tapered transition portion and an impingement flow sleeve surrounding the tapered transition portion, wherein the impingement flow sleeve is one of a second flow sleeve or a portion of the first flow sleeve; wherein the tapered transition portion includes an aft frame at an aft end of the tapered transition portion, and the resonating chamber is adjacent to the aft frame; and wherein an impingement annulus is defined between the tapered transition portion and the impingement flow sleeve, wherein the impingement annulus is one of a second annulus or a portion of the first annulus, and the resonating tube neck includes a second end in fluid communication with the combustion chamber;
(f) wherein the body defining the resonating chamber is at least partially disposed within the aft frame, and the resonating tube neck includes a second end in fluid communication with the combustion chamber; or
(g) wherein the body defining the resonating chamber is disposed on an outside of the impingement annulus, and the resonating tube neck has a second end in fluid communication with the impingement annulus.

22. The GT system of claim 21, wherein the at least two resonating tubes are each configured to dampen different respective frequencies.

23. The combustor of claim 1, wherein the acute angle of each side wall is selected to reduce drag induced thereby relative to an amount of drag experienced by the respective side wall at a right angle to a flow direction in the annular flow passage during operation of the combustor.

24. The combustor of claim 23, wherein the first wall is smaller in an axial direction of the combustor than a distance between opposed side walls of the plurality of side walls of the resonating chamber at the combustion liner in the axial direction of the combustor.

25. The GT system of claim 12, wherein the acute angle of each side wall is selected to reduce drag induced thereby relative to an amount of drag experienced by the respective side wall at a right angle to a flow direction in the annular flow passage during operation of the combustor.

26. The combustor of claim 25, wherein the first wall is smaller in an axial direction of the combustor than a distance between opposed side walls of the plurality of side walls of the resonating chamber at the combustion liner in the axial direction of the combustor.

27. A combustor for a gas turbine system, the combustor comprising:
an additively manufactured (AM) combustor body including a one-piece member including:
a combustion liner defining a combustion chamber and including a cylindrical portion and a tapered transition portion; and
a resonating tube configured to dampen acoustic pressure oscillations of combustion gases in the combustor, the resonating tube including a body defining a resonating chamber and a resonating tube neck having a first end in fluid communication with the resonating chamber and a second end in fluid communication with the combustion chamber;
wherein the AM combustor body includes a plurality of parallel, sintered metal layers;
wherein at least part of the combustion liner is surrounded by a flow sleeve arranged to be radially between, in a radial direction of the combustor, the combustion liner and an outer casing of a gas turbine system when the combustor is installed therein;
wherein an annular flow passage is defined between the flow sleeve and an outer surface of the combustion liner;
wherein the body defining the resonating chamber includes:
a first wall parallel to the combustion liner and outwardly spaced apart therefrom in the radial direction of the combustor, wherein the first wall is also radially inwardly spaced apart from an inner surface of the flow sleeve in the annular flow passage; and
a plurality of side walls that are positioned in the annulus and that extend at an acute angle from the combustion liner to the first wall of the body, wherein the acute angle between each side wall and the combustion liner is selected to reduce drag induced thereby during operation of the combustor relative to an amount of drag experienced by the respective side wall at a right angle to a flow direction in the annular flow passage during operation of the combustor.

28. The combustor of claim 27, wherein the first wall is smaller in an axial direction of the combustor than a distance between opposed side walls of the plurality of side walls of the resonating chamber at the combustion liner in the axial direction of the combustor.
